(19) United States
(12) Patent Application Publication
(10) Pub. No.: US 2020/0159556 A1
(43) Pub. Date: May 21, 2020

(54) TRAFFIC FORWARDING DURING MIGRATION

(71) Applicant: Microsoft Technology Licensing, LLC, Redmond, WA (US)

(72) Inventors: Harish Kumar CHANDRAPPA, Bothell, WA (US); Vishal TANEJA, Redmond, WA (US); Deven JAGASIA, Kirkland, WA (US); Milan DASGUPTA, Seattle, WA (US); Xinyan ZAN, Sammamish, WA (US); Deepak BANSAL, Bellevue, WA (US); Daniel FIRESTONE, Redmond, WA (US); Michal Czeslaw ZYGMUNT, Bellevue, WA (US); Rishabh TEWARI, Sammamish, WA (US)

(21) Appl. No.: 16/198,568

(22) Filed: Nov. 21, 2018

(51) Int. Cl. G06F 9/455; G06F 12/109; H04L 12/741; H04L 12/801; H04L 12/931

(52) U.S. Cl. CPC G06F 9/45558; G06F 12/109; H04L 45/745; G06F 2009/45595; H04L 49/70; G06F 2009/45583; H04L 47/10

(57) ABSTRACT

Techniques are disclosed for communicating data in a virtualized environment comprising virtual machines executing on one or more computing devices. An underlying physical destination address of a virtual machine executing on a virtual network is changed from a first physical address to a second physical address. A traffic forwarder function is executed on a virtual switch within the virtual network. The traffic forwarder function is executed during a time threshold determined based on a reprogramming time for network devices in the virtualized environment to update the underlying physical destination address. A data packet addressed to the first physical address is by the traffic forwarder function on a network external to the virtual network. A destination address of the data packet is updated from the first physical address to the second physical address. The data packet is forwarded to the updated destination address.

### BACKGROUND

A data center is a facility that houses computer systems and various networking, storage, and other related components. Data centers may, for example, provide computing services to businesses and individuals as a remote computing service or provide “software as a service” (e.g., cloud computing).

To facilitate efficient utilization of data center resources, virtualization technologies allow a physical computing device to host one or more virtual machines (VM) that appear and operate as independent computer devices to a connected user. The data center can create, maintain or delete virtual machines in a dynamic manner.

Live migration is a mechanism used to move a running virtual machine's state (memory, storage and networking) between physical machines while minimizing the virtual machine's downtime. Live migration is used in the cloud in many scenarios including disruptive BIOS update, cluster defragmentation, and network switch update to avoid downtime to the users' virtual machines.

It is with respect to these considerations and others that the disclosure made herein is presented.

### SUMMARY

The disclosed embodiments describe technologies for implementing a traffic forwarder on a live migration source virtual machine to forward traffic from the source virtual machine to a destination virtual machine to minimize packet loss and connectivity downtime during the live migration process.

During live migration, a virtual machine's physical IP address may change. While live migration is one scenario in which the virtual machine's physical IP address may change, the physical address may be changed for other reasons as well, for example when switching to a backup virtual machine. Although the virtual machine's physical address changes, the virtual machine's virtualized IP address stays the same. However, as a result of the physical IP address change, the virtual machine's virtual IP address to physical IP address mapping will change. Until this mapping change is propagated to all virtual machine ports in the virtual network for within-virtual network traffic and to other components such as the software load balancer for virtual IP traffic, data traffic will continue to flow to the live migration source virtual machine. This may cause packet loss and connectivity downtime during live migration for the virtual machine that is being live migrated, or otherwise had its physical IP address changed. To minimize packet loss and connectivity downtime during this process, a traffic forwarder may be implemented on the source virtual machine to forward traffic destined to the source virtual machine to the target virtual machine.

In one embodiment, since the physical address changes after live migration across the VLAN, a traffic forwarder may be implemented in a virtual switch such as the VFP (virtual filtering platform) that is configured to send packets that arrive on the old physical address and redirect the packets to the new physical address. In one embodiment, a hairpin layer may be implemented for the port that implements that forwarder. In one embodiment, the traffic forwarder may rewrite the destination IP address.

In one embodiment, the traffic forwarder is enabled before a blackout phase of the live migration process and remains enabled until a period of time sufficient to notify all hosts about the new physical address. The control plane may determine when live migration is fully completed and when to terminate and/or delete the traffic forwarder.

The MAC address associated with the physical address may also be changed when the IP address for the data packet is updated. The physical address route layer in the VFP may be used to perform MAC lookup when the physical address changes.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating a data center for providing virtualized resources in accordance with the present disclosure;

FIG. 2 is a diagram illustrating a data center for providing virtualized resources in accordance with the present disclosure;

FIG. 3 is a diagram illustrating allocation and migration of virtual machine instances in accordance with the present disclosure;

FIG. 4 is a diagram illustrating allocation and migration of virtual machine instances in accordance with the present disclosure;

FIG. 5 is a diagram illustrating an example of a traffic forwarder function in accordance with the present disclosure;

FIG. 6 is a flowchart depicting an example procedure for communicating data in a virtualized environment in accordance with the present disclosure;

FIG. 7 is a flowchart depicting an example procedure for communicating data in a virtualized environment in accordance with the present disclosure;

FIG. 8 is an example computing device in accordance with the present disclosure.

### DETAILED DESCRIPTION

Described herein are methods and systems for minimizing user interruptions during a change in physical address for a virtual machine, such as during a virtual machine migration. Live migration of virtual machines may be performed when a running virtual machine is migrated to another physical host rather than being rebooted. Live migration may be performed, for example, due to hardware faults due to disks, memory, CPU, etc., as well as other reasons such as network device maintenance, power device maintenance, and host OS or BIOS updates.

Live migration of virtual machines allows for the user to continue to use their virtual machines unimpacted during the migration process. Network connections and virtual machine states are preserved during the live migration. During the final phase of the live migration, the virtual machine may be briefly paused during the final transition to the new virtual machine. In some implementations, live migration may be performed in three phases: pre-migration, migration and post-migration. During the pre-migration phase, the preparation and setup tasks for migration are performed. In the migration phase, the virtual machine state is moved. During the post-migration phase, finalization and cleanup operations are performed.

During the pre-migration phase, preparation and setup processes may be performed before the actual migration process begins. The management plane may determine a suitable destination node based on various platform constraints. Once the destination node is selected, the management plane may drive the source node through a preparation phase which may include exporting the virtual machine configuration after setting up authorization for source-destination node communication. The management plane may cause the destination node to continue through a preparation phase which creates a placeholder virtual machine using the exported virtual machine configuration after finishing authorization related steps. The platform may use the planned virtual machine to make changes to any of the virtual machine's static information, while the virtual machine is still running on the source. During this phase, the virtual machine remains running on the source node and there is no impact to virtual machine availability or performance.

Once the pre-migration phase is complete, the platform management plane may initiate the migration phase on the source node. During a brownout phase, the virtual machine's memory and local disk state may be transferred to the destination node while the virtual machine is still running on the source node. The brownout phase may be followed by the blackout phase. Once the virtual machine's runtime state is copied to the destination, the virtual machine is paused and a final runtime state transfer of virtual devices and memory (if any) is performed, before starting the virtual machine on the destination node.

The brownout phase may begin at the initiation of memory/disk transfer and end once the virtual machine is paused. To re-copy dirtied pages during the memory transfer phase, the pages may be marked-read only. For local disk IO, the disk writes may be mirrored and written to both the source and destination nodes before acknowledging the application. The length of the brownout may depend on the virtual machine size and network bandwidth available for data transfer.

Once the brownout phase ends, the virtual machine may be place in a blackout phase which may include a suspended state on both the source and destination nodes. A live migration agent may transfer additional container state information before starting the destination virtual machine. For example, the virtual machine's remote disk write cache may need to be flushed before starting the virtual machine on the destination. In case of a failure to transfer the container state or if there is a flush failure, the virtual machine may be started on the source node. During this phase, the existing networking flow states may be transferred to the new virtual machine to minimize interruptions in network connectivity. The duration between pausing of a virtual machine on the source until the virtual machine starts on a source or destination, may be referred to as the blackout phase as the virtual machine is neither running on the source nor on the destination nodes. The length of the blackout may be based on the amount of virtual machine state that is remaining to transfer after the virtual machine is paused and the network bandwidth that is available.

In the post-migration phase, the management plane may mark one of the source or destination virtual machines as currently active, depending on the success or failure of the migration operation. Upon successful migration, the destination virtual machine may be marked as active and upon failure the source virtual machine may be marked active. A cleanup process may be driven across the source and destination nodes. In addition to cleanup, the source virtual machine may be destroyed upon successful migration and the destination virtual machine may be destroyed upon a failed migration. During this phase, the virtual machine is either running on the source or destination and there is no virtual machine downtime.

Virtual machine live migration may use pre-copy memory migration, where the virtual machine memory state is copied to the destination while the virtual machine is still running on the source. The memory pages which are dirtied during the initial transfer may be re-copied until the dirtied state can be copied when the virtual machine is paused. The local disk migration may use IO mirroring to make sure that disk IOs on the source are written to both source and destination disks.

When a virtual machine is migrated within the same VLAN, for example if the virtual machine is moved to another slot in the same rack, from a networking perspective it may not be necessary to change the IP address of packets addressed to the migrated virtual machine because the old and new virtual machine locations are in the same rack. Thus there may be no outages in connectivity, at least due to missed packets.

However, in a cross-VLAN situation, for example if the blades in a rack are full and the virtual machine must be migrated to another rack, the virtual machine must move to another rack. In this case, the virtual networking resources will not remain the same, and a new physical IP address needs to be used for packets addressed to the migrated virtual machine. The present disclosure described techniques for reducing interruptions to network traffic when a virtual machine is migrated to a new physical address. In one embodiment, a traffic forwarding mechanism or function may be implemented so that data traffic that is addressed to a first physical address is automatically forwarded to the second physical address. Once migration completes, the first virtual machine may be destroyed and all the traffic may be sent to the new virtual machine.

In one embodiment, once the blackout phase completes, the traffic forwarder may be invoked. Existing connections may be allowed to continue until they expire. Without the traffic forwarder, data traffic to the first physical address may be dropped and existing connections may be dropped. When the virtual machine becomes live at the second physical address, the traffic forwarder may continue to run as the physical addresses are updated in the control plane and consolidated across the network. Without the traffic forwarder, connections may be dropped and attempts to reconnect may fail because the new physical address has not been propagated.

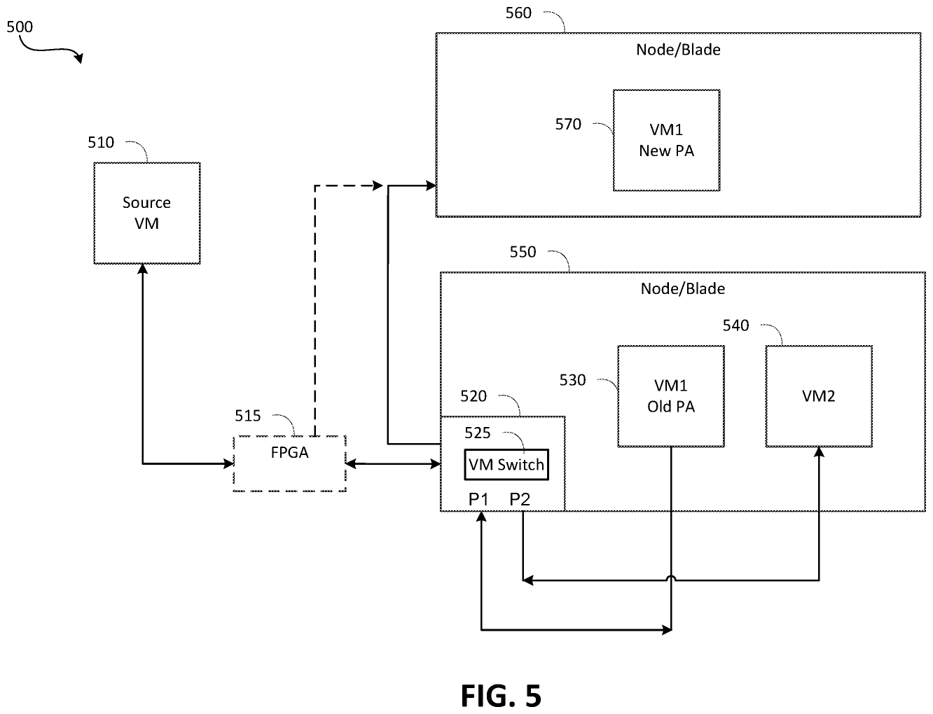

In one embodiment, the traffic forwarder may be implemented at the first virtual machine, or where the original virtual machine was located. A networking agent may be configured to trigger the traffic forwarder. Referring to FIG. 5, a node 550 is illustrated that may run a hypervisor which hosts virtual machines 530 and 540. A networking stack may be implemented, and a virtual machine switch 525 may be implemented with multiple ports that are connected to the external network. In one implementation, a virtual switch such as a virtual filtering platform (VFP) 520 may be implemented that filters packets and applies network policies. The VFP 520 may apply policies to data traffic from external virtual machines, and the traffic forwarder may redirect the traffic before arriving at any particular virtual machine, forwarding the traffic back out to the external network to the physical address of the new node for the virtual machine.

In some embodiments, the traffic forwarder may be implemented in components other than the VFP, such as an FPGA 515 or other peripheral function or device. An advantage of using a traffic forwarder in this manner is that implementing a forwarder at a router is the lack of scalability as more virtual machines are migrated. Additionally, the traffic forwarder may only be activated for a specific virtual machine that is to be migrated, with flexibility as to where the forwarder can be optimally placed. In the example shown on FIG. 5, a packet addressed to VM1 530 on node 550 has been migrated to VM1 570 on node 560. A data packet sent to VM1 530 on node 550 may be redirected to VM1 570 on node 560, by updating the destination address on the data packet, or by encapsulating the data packet and addressing the packet to the physical address of VM1 570 on node 560.

The traffic forwarder may remain active for a time period that may be referred to as a forwarding window or a time threshold. The forwarding window may be determined based on a time period during which existing connections are provided sufficient time to complete, as well as time for the new physical address information to be propagated. In some embodiments the time threshold may be a fixed value. The fixed value may be determined based on a known time during which the new physical address information will be propagated. In some embodiments, the time threshold may be determined automatically. In one embodiment, the time threshold may be determined based on a notification indicating that the traffic forwarder may be terminated. The notification may be generated based on determining that the new physical address information has been propagated. In another embodiment, the time threshold may be implemented by a timer. The timer can implement a fixed time. The timer can also implement a variable time that may be determined based on one or more factors such as network conditions.

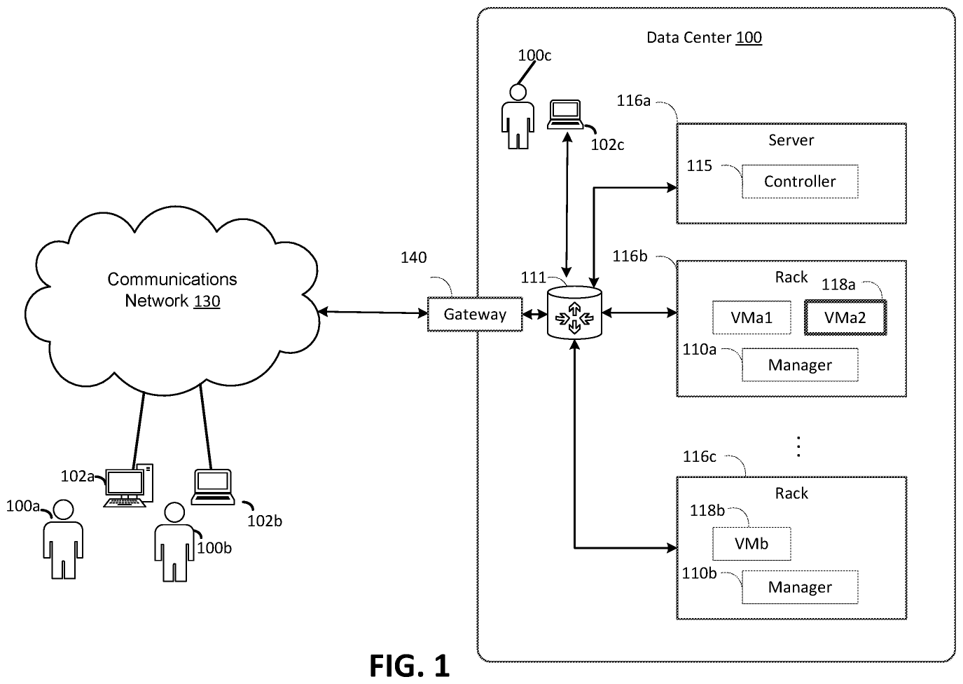

FIG. 1 illustrates an example computing environment in which the embodiments described herein may be implemented. FIG. 1 illustrates a data center 100 that configured to provide computing resources to users 100a, 100b, or 100c (which may be referred herein singularly as “a user 100” or in the plural as “the users 100”) via user computers 102a,102b, and 102c (which may be referred herein singularly as “a computer 102” or in the plural as “the computers 102”) via a communications network 130. The computing resources provided by the data center 100 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 100 may include servers 116a, 116b, and 116c (which may be referred to herein singularly as “a server 116” or in the plural as “the servers 116”) that provide computing resources available as virtual machines 118a and 118b (which may be referred to herein singularly as “a virtual machine 118” or in the plural as “the virtual machines 118”). The virtual machines 118 may be configured to execute applications such as Web servers, application servers, media servers, database servers, and the like. Other resources that may be provided include data storage resources (not shown on FIG. 1) and may include file storage devices, block storage devices, and the like. Servers 116 may also execute functions that manage and control allocation of resources in the data center, such as a controller 115. Controller 115 may be a fabric controller or another type of program configured to manage the allocation of virtual machines on servers 116.

Referring to FIG. 1, communications network 130 may, for example, be a publicly accessible network of linked networks and may be operated by various entities, such as the Internet. In other embodiments, communications network 130 may be a private network, such as a corporate network that is wholly or partially inaccessible to the public.

Communications network 130 may provide access to computers 102. Computers 102 may be computers utilized by users 100. Computer 102a,102b or 102c may be a server, a desktop or laptop personal computer, a tablet computer, a smartphone, a set-top box, or any other computing device capable of accessing data center 100. User computer 102a or 102b may connect directly to the Internet (e.g., via a cable modem). User computer 102c may be internal to the data center 100 and may connect directly to the resources in the data center 100 via internal networks. Although only three user computers 102a,102b, and 102c are depicted, it should be appreciated that there may be multiple user computers.

Computers 102 may also be utilized to configure aspects of the computing resources provided by data center 100. For example, data center 100 may provide a Web interface through which aspects of its operation may be configured through the use of a Web browser application program executing on user computer 102. Alternatively, a stand-alone application program executing on user computer 102 may be used to access an application programming interface (API) exposed by data center 100 for performing the configuration operations.

Servers 116 may be configured to provide the computing resources described above. One or more of the servers 116 may be configured to execute a manager 120a or 120b (which may be referred herein singularly as “a manager 120” or in the plural as “the managers 120”) configured to execute the virtual machines. The managers 120 may be a virtual machine monitor (virtual machineM), fabric controller, or another type of program configured to enable the execution of virtual machines 118 on servers 116, for example.

It should be appreciated that although the embodiments disclosed above are discussed in the context of virtual machines, other types of implementations can be utilized with the concepts and technologies disclosed herein. For example, the embodiments disclosed herein might also be utilized with computing systems that do not utilize virtual machines.

In the example data center 100 shown in FIG. 1, a router 111 may be utilized to interconnect the servers 116a and 116b. Router 111 may also be connected to gateway 140, which is connected to communications network 130. Router 111 may manage communications within networks in data center 100, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 1 has been greatly simplified and that many more networks and networking devices may be utilized to interconnect the various computing systems disclosed herein. These network topologies and devices should be apparent to those skilled in the art.

It should also be appreciated that data center 100 described in FIG. 1 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

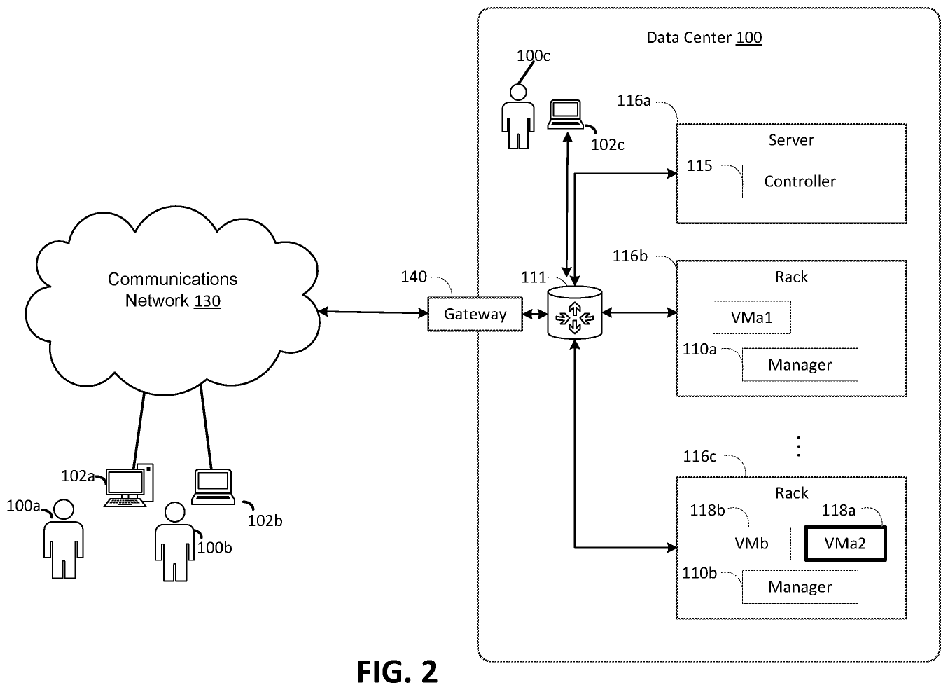

As illustrated in FIG. 1, in one example, one of the virtual machines 118a labeled virtual machinea2 may be identified as a virtual machine that should be migrated from server 116b which is currently hosting the virtual machine. Server 116c may be identified, based on one or more criteria, as a destination server for the virtual machine. Referring to FIG. 2, virtual machine 118a VMa2 may be migrated to server 116c when a performance threshold is met. In an embodiment, virtual machine 118a VMa2 may be migrated subsequent to shutting down the virtual machine at the current host 116b and prior to rebooting the virtual machine at the new host 116c. The migration may utilize a previously scheduled migration for maintenance time associated with server 116b to accomplish the migration. Additionally, local state data for virtual machine 118a VMa2 may also be migrated to server 116c based on a determination that migration of the local state data meets one or more criteria.

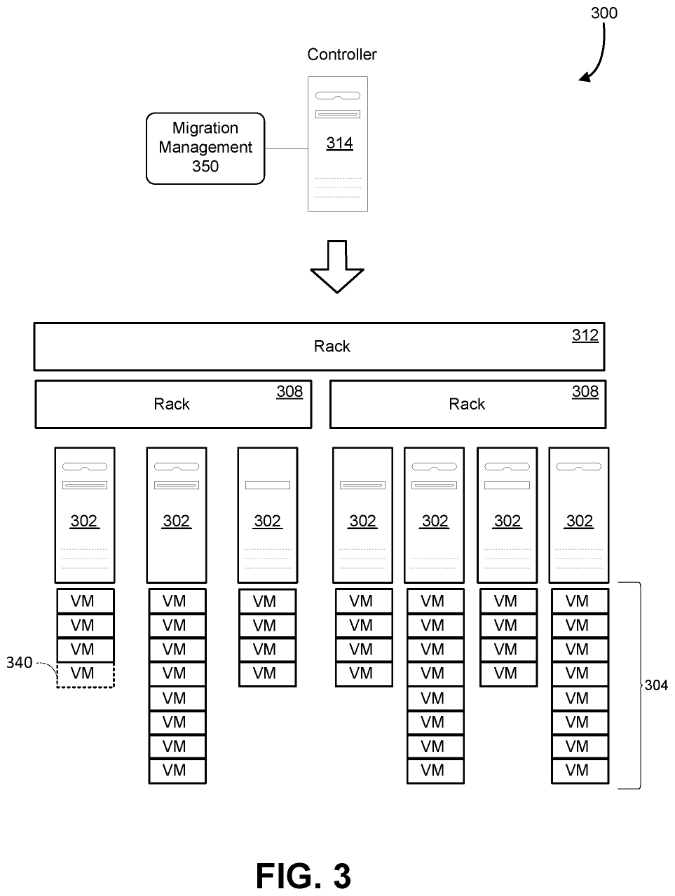

In some embodiments, such as in FIG. 3, illustrated is a data center 300 that may be viewed as a collection of shared computing resources and shared infrastructure. For example, as shown in FIG. 3, a data center 300 may include virtual machine containers 304, physical hosts 302, racks 308, and data center 312. A virtual machine container 304 may be referred to as a resource slot. The physical hosts 302 may vary in hardware and/or software configurations and thus may not be identical whether they are on the same physical rack or data center. A physical host 302 may be shared by multiple virtual machine containers 304, each container 304 being capable of hosting a virtual machine. Multiple physical hosts 302 may share resources such as a power supply (not shown on FIG. 3) provided on data center 312. Data center 312 may also include one or more routers (also not shown on FIG. 3) which may service multiple physical hosts 302 to route network traffic. A controller or provisioning server 314 may include a memory and processor configured with instructions to manage workflows for provisioning and de-provisioning computing resources as well as detecting health and/or failure of computing resources.

A provisioning server 314 may determine a placement of a resource within the data center. In some embodiments, this placement may be based at least in part on available computing resources and/or relationships between computing resources.

In an embodiment, the service provider may implement a migration management function 350 that is configured to identify when an event is detected that is associated with maintenance of a virtual machine. For example, when a command or request is sent or received that is associated with maintenance of a virtual machine, upon detection of the command/request, the migration management function 350 may determine if the virtual machine associated with the detected command/request requires maintenance such that a migration should be scheduled. This determination may be made based on one or more criteria. For example, the migration management function 350 may determine if the virtual machine requires or would benefit from being hosted on an alternate computing device with different or improved features. The service provider may determine if a candidate host computing device is available that meets or exceeds the criteria for a machine that has such features. It should be noted that the migration management function 350 may execute on provisioning server 314. In some embodiments, the functionality of migration management function 350 may also execute in whole or in part within the physical hosts 302. The functionality may also be distributed between the provisioning server 314 and physical hosts 302.

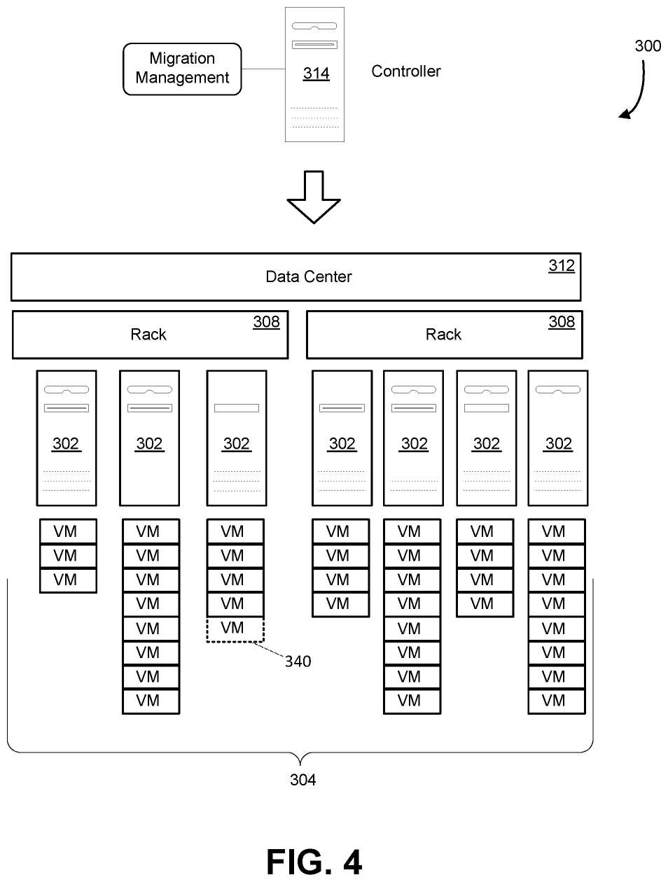

Referring to FIG. 3, virtual machine 340 may be identified as a virtual machine that should be migrated from the physical host 302 which is currently hosting the virtual machine. Another physical host may be identified, based on one or more criteria, as a destination host for the virtual machine 340. Referring to FIG. 4, virtual machine 340 may be migrated to an identified physical host 302 when a performance threshold is met. It should be noted that virtual machines may be migrated between physical hosts within the same rack, within the same grouping, between groupings, between data centers, or between any two devices regardless of physical location and specific hardware and/or software configurations. In an embodiment, virtual machine 340 may be migrated subsequent to shutting down the virtual machine at the current host and prior to rebooting the virtual machine at the new host. The migration may utilize a previously scheduled migration for maintenance time associated with the current or source physical host.

The implementation of a traffic forwarder in accordance to the disclosed embodiments may allow for virtual machines to be live migrated between two hosts which are on different VLANs with reduced impact on the users of the virtual machines. As used herein, the source node may refer to the host from which virtual machine is getting live migrated. The destination node may refer to the host to which virtual machine is getting live migrated.

In an embodiment, a hairpin layer may be implemented for the port that performs the rewrite of the destination IP address, where communication between two hosts are enabled using their mapped endpoints. For example, a virtual machine on the VLAN may access another virtual machine on the VLAN via the external IP address of the VLAN, with port forwarding to direct requests to the appropriate virtual machine. The traffic forwarder may be enabled before the blackout phase and remain enabled until hosts are notified about the new physical address. The control plane may determine when live migration is fully completed and when to delete the forwarding layer. If the destination MAC is to be rewritten, the MAC to TOR MAC may be rewritten, or the physical address route layer may rewrite the MAC. The traffic forwarder may continue to execute even if the old virtual machine no longer exists. Hence, the virtual port on the virtual switch may be maintained as long as the traffic forwarder continues to execute.

In an embodiment, when a packet leaves the host with the old physical address, the destination IP address may be changed from the old physical address to the new physical address, and the physical address route rule may change the destination MAC. In another embodiment, the packet may be encapsulated with an outer layer that redirects the packet from the old physical address to the new physical address, leaving the original packet unmodified. The encapsulation may be implemented using a custom protocol or a standard protocol such as NVGRE, VXLAN, or Mobile IPv4/IPv6.

For the flow state for the VFP port on the destination host, entries with the old physical address may be updated to the new physical address. In one implementation, the HLIP address may be changed. A layer-specific flag may be used to indicate that all current flows of that layer should be updated by replacing the old physical address with the new physical address.

In an embodiment, a VFP API may be implemented that embodies a layer-level command to replace addresses.

One to one mapping between current addresses and new addresses may be maintained. Current and new addresses may be specified in order. An agent may be configured to reconcile VFP flows in its layers.

To avoid replacing addresses in a loop, an address field in a flow may only be updated once. This may prevent cyclic replace of addresses where address A needs to be changed to address B and address B needs to be changed to address C. For example, if a source address has been replaced from A to B, the flow's source address field will not be updated from B to C. The assumption is that B->C only applies to fields with address B which were equal to B in the original flow table i.e. before any of the addresses were changed.

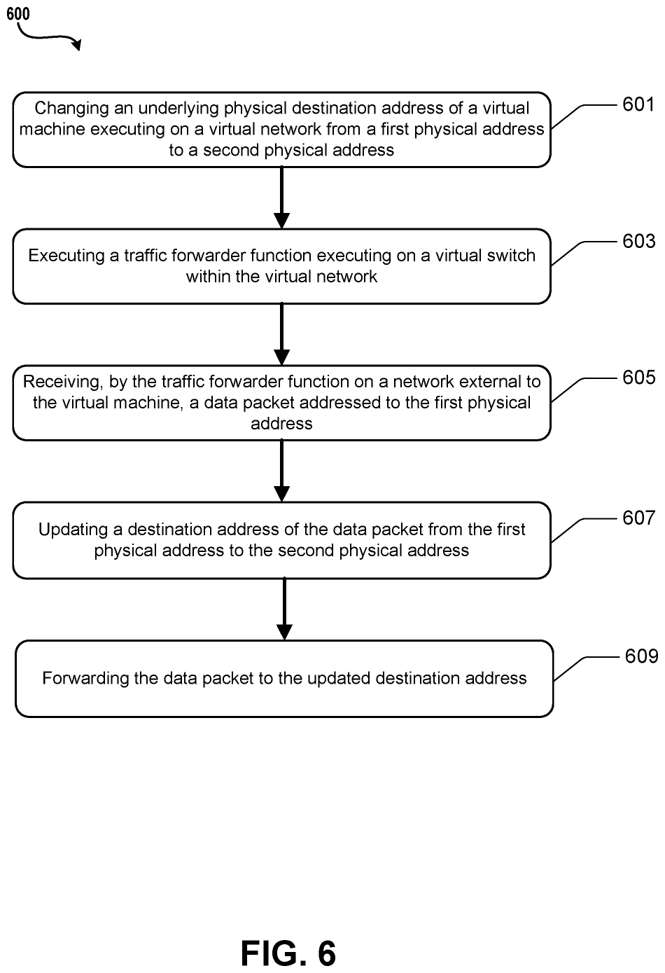

Turning now to FIG. 6, illustrated is an example operational procedure for communicating data in a virtualized environment in accordance with the present disclosure. The operational procedure may be implemented in a system comprising one or more computing devices. Referring to FIG. 6, operation 601 illustrates changing an underlying physical destination address of a virtual machine executing on a virtual network from a first physical address to a second physical address.

Operation 601 may be followed by operation 603. Operation 603 illustrates executing a traffic forwarder function executing on a virtual switch within the virtual network. In an embodiment, the traffic forwarder is executed during a time threshold determined based on a reprogramming time for network devices in the virtualized environment to update the underlying physical address.

Operation 603 may be followed by operation 605. Operation 605 illustrates receiving, by the traffic forwarder function on a network external to the virtual machine, a data packet addressed to the first physical address.

Operation 605 may be followed by operation 607. Operation 607 illustrates updating a destination address of the data packet from the first physical address to the second physical address.

Operation 607 may be followed by operation 609. Operation 609 illustrates forwarding, via the traffic forwarder, the data packet to the updated destination address.

In an embodiment, the time threshold may be determined by a virtual machine manager that is managing the migration of the virtual machines. The time threshold may also be determined via a notification that traffic forwarding may be terminated. The notification may be sent in response to determining that network devices in the virtualized environment have been reprogrammed with the updated physical destination address. The time threshold may be a static time value. The time threshold may be implemented as a timer with a value based on the time threshold.

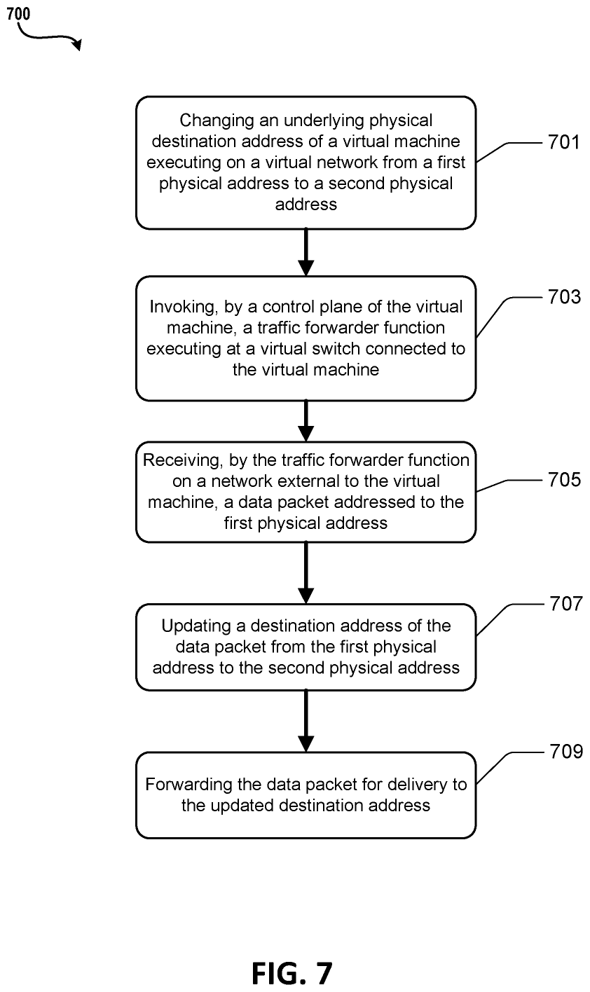

Referring to FIG. 7, illustrated is another example operational procedure for communicating data in a virtualized environment. The operational procedure may be implemented in a system comprising one or more computing devices. Referring to FIG. 7, operation 701 illustrates changing an underlying physical destination address of a virtual machine executing on a virtual network from a first physical address to a second physical address.

Operation 701 may be followed by operation 703. Operation 703 illustrates receiving, from a network external to the virtual network, a data packet addressed to the first physical address.

Operation 703 may be followed by operation 705. Operation 705 illustrates updating a destination address of the data packet from the first physical address to the second physical address.

Operation 705 may be followed by operation 707. Operation 707 illustrates forwarding the data packet to the network external to the virtual network.

### EXAMPLE CLAUSES

The disclosure presented herein may be considered in view of the following clauses.

Example Clause A, a method for communicating data in a virtualized environment comprising virtual machines executing on one or more computing devices, the method comprising:

changing an underlying physical destination address of a virtual machine executing on a virtual network from a first physical address to a second physical address;

executing a traffic forwarder function executing on a virtual switch within the virtual network, wherein the traffic forwarder is executed during a time threshold determined based on a reprogramming time for network devices in the virtualized environment to update the underlying physical destination address;

receiving, by the traffic forwarder function on a network external to the virtual machine, a data packet addressed to the first physical address;

updating a destination address of the data packet from the first physical address to the second physical address; and

forwarding, via the traffic forwarder, the data packet to the updated destination address.

Example Clause B, the method of Example Clause A, wherein the traffic forwarder is implemented in a virtual filtering platform (VFP).

Example Clause C, the method of any one of Example Clauses A through B, wherein the virtual machine is migrated from the first physical address to the second physical address.

Example Clause D, the method of any one of Example Clauses A through C, wherein the updating comprises encapsulating the data packet.

Example Clause E, the method of any one of Example Clauses A through D, wherein the traffic forwarder function is invoked before a blackout phase of the migration.

Example Clause F, the method of any one of Example Clauses A through E, wherein the time threshold is determined via a notification that traffic forwarding may be terminated.

Example Clause G, the method of any one of Example Clauses A through F, wherein the notification is based on determining that the network devices have been updated with the updated physical address.

Example Clause H, the method of any one of Example Clauses A through G, further comprising allowing existing connections to the virtual machine to continue until the connections expire.

Example Clause I, system, comprising:

one or more processors; and

a memory in communication with the one or more processors, the memory having computer-readable instructions stored thereupon that, when executed by the one or more processors, cause the system to perform operations comprising:

changing an underlying physical destination address of a virtual machine executing on a virtual network from a first physical address to a second physical address;

invoking, by a control plane of the virtual machine, a traffic forwarder function executing at a virtual switch connected to the virtual machine;

receiving, by the traffic forwarder function on a network external to the virtual machine, a data packet addressed to the first physical address;

updating a destination address of the data packet from the first physical address to the second physical address; and

forwarding the data packet for delivery to the updated destination address.

Example Clause J, the system of Example Clause I, wherein the traffic forwarder is implemented in a virtual filtering platform (VFP).

Example Clause K, the system of any one of Example Clauses I through J, wherein the traffic forwarder is implemented in a field programmable gate array (FPGA).

Example Clause L, the system of any one of Example Clauses I through K, wherein the virtual machine is migrated from the first physical address to the second physical address.

Example Clause M, the system of any one of Example Clauses I through L, wherein the traffic forwarder function is invoked before the virtual machine is launched at the second physical address.

Example Clause N, the system of any one of Example Clauses I through M, further comprising terminating the traffic forwarder function after a time threshold determined by a notification indicating that traffic forwarding may be terminated.

Example Clause O, the system of any one of Example Clauses I through N, wherein the predetermined time is based in part on a time to propagate the second physical address to one or more network devices.

Example Clause P, the system of any one of Example Clauses I through O, further comprising allowing existing connections to the virtual machine to continue until the connections expire.

Example Clause Q, a computer-readable storage medium having computer-executable instructions stored thereupon which, when executed by one or more processors of a computing device, cause the computing device to perform operations comprising:

in response to a change to an underlying physical destination address of a virtual machine executing on a virtual network from a first physical address to a second physical address and during a time threshold that is determined based on an expected reprogramming time for network devices to update routing information for the virtual machine;

receiving, from a network external to the virtual machine, a data packet addressed to the first physical address;

updating a destination address of the data packet from the first physical address to the second physical address; and

forwarding the data packet to the updated destination address of the virtual machine.

Example Clause R, the computer-readable storage medium of Example Clause Q, wherein the virtual machine is migrated from the first physical address to the second physical address.

Example Clause S, the computer-readable storage medium of any of Example Clauses Q through R, further comprising forwarding begins before the virtual machine is launched at the second physical address.

Example Clause T, the computer-readable storage medium of any one of Example Clauses Q through S, wherein the forwarding is terminated after a predetermined time that is based in part on a time to propagate the second physical address to one or more network devices.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, or a computing system or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures and other types of structures that perform particular tasks or implement particular abstract data types.

Those skilled in the art will also appreciate that the subject matter described herein may be practiced on or in conjunction with other computer system configurations beyond those described herein, including multiprocessor systems. The embodiments described herein may also be practiced in distributed computing environments, where tasks are performed by remote processing devices that are linked through a communications network. In a distributed computing environment, program modules may be located in both local and remote memory storage devices.

Networks established by or on behalf of a user to provide one or more services (such as various types of cloud-based computing or storage) accessible via the Internet and/or other networks to a distributed set of clients may be referred to as a service provider. Such a network may include one or more data centers such as data center 100 illustrated in FIG. 1, which are configured to host physical and/or virtualized computer servers, storage devices, networking equipment and the like, that may be used to implement and distribute the infrastructure and services offered by the service provider.

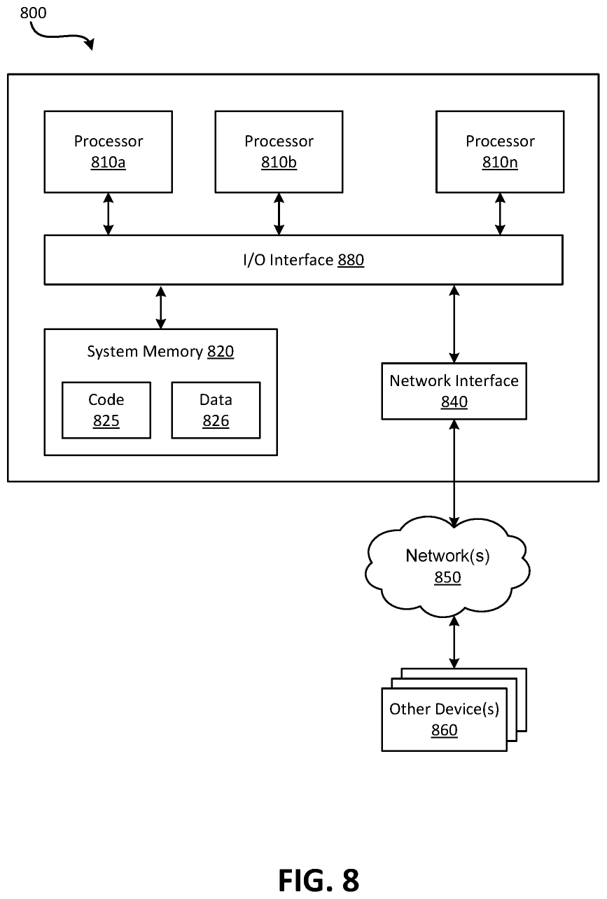

In some embodiments, a server that implements a portion or all of one or more of the technologies described herein, including the techniques to implement the capturing of network traffic may include a general-purpose computer system that includes or is configured to access one or more computer-accessible media. FIG. 8 illustrates such a general-purpose computing device 800. In the illustrated embodiment, computing device 800 includes one or more processors 810a, 810b, and/or 810n (which may be referred herein singularly as “a processor 810” or in the plural as “the processors 810”) coupled to a system memory 88 via an input/output (I/O) interface 830. Computing device 800 further includes a network interface 840 coupled to I/O interface 830.

In various embodiments, computing device 800 may be a uniprocessor system including one processor 810 or a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA.

System memory 88 may be configured to store instructions and data accessible by processor(s) 810. In various embodiments, system memory 88 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 88 as code 825 and data 826.

In one embodiment, I/O interface 830 may be configured to coordinate I/O traffic between the processor 810, system memory 88, and any peripheral devices in the device, including network interface 840 or other peripheral interfaces. In some embodiments, I/O interface 830 may perform any necessary protocol, timing, or other data transformations to convert data signals from one component (e.g., system memory 88) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components. Also, in some embodiments some or all of the functionality of I/O interface 830, such as an interface to system memory 88, may be incorporated directly into processor 810.

Network interface 840 may be configured to allow data to be exchanged between computing device 800 and other device or devices 860 attached to a network or network(s) 850, such as other computer systems or devices as illustrated in FIGS. 1 through 4, for example. In various embodiments, network interface 840 may support communication via any suitable wired or wireless general data networks, such as types of Ethernet networks, for example. Additionally, network interface 840 may support communication via telecommunications/telephony networks such as analog voice networks or digital fiber communications networks, via storage area networks such as Fibre Channel SANs or via any other suitable type of network and/or protocol.

In some embodiments, system memory 88 may be one embodiment of a computer-accessible medium configured to store program instructions and data as described above for FIGS. 1-19 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 800 via I/O interface 830. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 800 as system memory 88 or another type of memory. Further, a computer-accessible medium may include transmission media or signals such as electrical, electromagnetic or digital signals, conveyed via a communication medium such as a network and/or a wireless link, such as may be implemented via network interface 840. Portions or all of multiple computing devices, such as those illustrated in FIG. 8, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 8, may include other components that are not explicitly shown in FIG. 8, or may utilize an architecture completely different than that shown in FIG. 8.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for communicating data in a virtualized environment comprising virtual machines executing on one or more computing devices, the method comprising:
changing an underlying physical destination address of a virtual machine executing on a virtual network from a first physical address to a second physical address;
executing a traffic forwarder function on a virtual switch within the virtual network, wherein the traffic forwarder is invoked after memory and local disk states are transferred to the virtual machine at the second physical address and the virtual machine at the first physical address is suspended, and terminated after a time threshold determined based on a reprogramming time for network devices in the virtualized environment to update the physical destination address from the first physical address to the second physical address;
receiving, by the traffic forwarder function on a network external to the virtual machine, a data packet addressed to the first physical address;
updating a destination address of the data packet from the first physical address to the second physical address; and
forwarding, via the traffic forwarder, the data packet to the updated destination address.

2. The method of claim 1, wherein the traffic forwarder is implemented in a virtual filtering platform (VFP).

3. The method of claim 1, wherein the virtual machine is migrated from the first physical address to the second physical address.

4. The method of claim 1, wherein the updating comprises encapsulating the data packet.

5. The method of claim 3, wherein the traffic forwarder function is invoked before a blackout phase of the migration.

6. The method of claim 1, wherein the time threshold is further based on a notification that traffic forwarding may be terminated.

7. The method of claim 6, wherein the notification is based on determining that the network devices have been updated with the updated physical address.

8. The method of claim 1, further comprising allowing existing connections to the virtual machine to continue until the connections expire.

9. A system, comprising:
one or more processors; and
a memory in communication with the one or more processors, the memory having computer-readable instructions stored thereupon that, when executed by the one or more processors, cause the system to perform operations comprising:
changing an underlying physical destination address of a virtual machine executing on a virtual network from a first physical address to a second physical address;
invoking, by a control plane of the virtual machine, a traffic forwarder function executing at a virtual switch connected to the virtual machine, the traffic forwarder function being invoked after memory and local disk states are transferred to the virtual machine at the second physical address and the virtual machine at the first physical address is suspended, and terminated after a time threshold determined based on a reprogramming time for network devices to update the physical destination address from the first physical address to the second physical address;
receiving, by the traffic forwarder function on a network external to the virtual machine, a data packet addressed to the first physical address;
updating a destination address of the data packet from the first physical address to the second physical address; and
forwarding the data packet for delivery to the updated destination address.

10. The system of claim 9, wherein the traffic forwarder is implemented in a virtual filtering platform (VFP).

11. The system of claim 9, wherein the traffic forwarder is implemented in a field programmable gate array (FPGA).

12. The system of claim 9, wherein the virtual machine is migrated from the first physical address to the second physical address.

13. The system of claim 12, wherein the traffic forwarder function is invoked before the virtual machine is launched at the second physical address.

14. The system of claim 9, wherein the time threshold is further determined by a notification that traffic forwarding may be terminated.

15. The system of claim 9, wherein the time threshold is further based in part on a time to propagate the second physical address to one or more network devices.

16. The system of claim 9, further comprising allowing existing connections to the virtual machine to continue until the connections expire.

17. A computer-readable storage medium having computer-executable instructions stored thereupon which, when executed by one or more processors of a computing device, cause the computing device to perform operations comprising:
in response to a change to an underlying physical destination address of a virtual machine executing on a virtual network from a first physical address to a second physical address and beginning after memory and local disk states are transferred to the virtual machine at the second physical address and the virtual machine at the first physical address is suspended, and ending after a time threshold that is determined based on an expected reprogramming time for network devices to update routing information for the virtual machine:
receiving, from a network external to the virtual machine, a data packet addressed to the first physical address;
updating a destination address of the data packet from the first physical address to the second physical address; and
forwarding the data packet to the updated destination address of the virtual machine.

18. The computer-readable storage medium of claim 17, wherein the virtual machine is migrated from the first physical address to the second physical address.

19. The computer-readable storage medium of claim 18, further comprising forwarding begins before the virtual machine is launched at the second physical address.

20. The computer-readable storage medium of claim 17, wherein the time threshold is further based on a time to propagate the second physical address to one or more network devices.
